(19) United States
(12) Patent Application Publication
(10) Pub. No.: US 2021/0358321 A1
(43) Pub. Date: Nov. 18, 2021

(54) SYSTEM AND METHOD FOR NATURAL LANGUAGE TRIAD ANALYSIS OF EDUCATIONAL TEXT

(71) Applicant: INTERNATIONAL BUSINESS MACHINES CORPORATION, Armonk, NY (US)

(72) Inventors: Mukundan Sundararajan, Bangalore (IN); Vishal Awal, Mumbai (IN); Jignesh K. Karia, Kalyan (IN)

(21) Appl. No.: 16/874,001

(22) Filed: May 14, 2020

(51) Int. Cl. G09B 7/02; G09B 5/06

(52) U.S. Cl. CPC G09B 7/02; G09B 5/065

(57) ABSTRACT

A method comprising receiving a text answer to an educational related question from a student and breaking up the text answer into a plurality of triads. Evaluating the plurality of triads to determine the student's comprehension of an educational subject that corresponds to the educational related question. Determining that the student's comprehension is lacking relating to the educational subject and automatically adjusting educational materials provided to the student, wherein the adjusted educational materials focuses on the areas of the educational subject that the student's comprehension was determined to be lacking.

### BACKGROUND

The present invention relates generally to the field of natural language processing, and more particularly to natural language processing of text submitted by a student.

Today a variety of learning platforms and methods provide remote teaming to a student. Learning has become more formal for even older people in the workforce as technology, innovations and larger knowledge corpus are forcing new skill needs in the world. MOOC courses, teaching with electronic aids, submersing people with data and information constantly, peppering people with constant messaging. Even with all these new methods, technology breakthroughs, AI and ML, how the human mind comprehends the information, forms the information links and applies it is still not well understood. Students learning measurement of how well they have understood a topic and can express it correctly in one of multiple ways is still a challenge for the knowledge and learning platforms. There is no specific way for determining how well the topic has been understood and how much of incorrect or a misunderstanding of the topic exists.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for automatically adjusting education material provided to a student based on a determined student comprehension.

A method comprising receiving a text answer to an educational related question from a student and breaking up the text answer into a plurality of triads. Evaluating the plurality of triads to determine the student's comprehension of an educational subject that corresponds to the educational related question. Determining that the student's comprehension is lacking relating to the educational subject and automatically adjusting educational materials provided to the student, wherein the adjusted educational materials focuses on the areas of the educational subject that the student's comprehension was determined to be lacking.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram illustrating a distributed educational platform processing environment, in accordance with an embodiment of the present invention.

FIG. 2 is a flowchart depicting operational steps of the educational platform process environment of FIG. 1, in accordance with an embodiment of the present invention.

FIG. 3 is a flowchart depicting operational steps of the educational platform process environment of FIG. 1 from the perspective of a student, in accordance with an embodiment of the present invention.

FIG. 4 is a block diagram of components of a computing device of the secure communication systems of FIG. 1, in accordance with embodiments of the present invention.

FIG. 5 depicts a cloud computing environment according to an embodiment of the present invention.

FIG. 6 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for an automatic educational software that provides educational teaching to a user, i.e. a student. Most educational software provides text, video, or audio lessons to teach the material to a user. The educational software usually provides only multiple-choice questions to the user to test his/her knowledge of the of the taught material. The educational software utilizes the user responses to the multiple-choice questions to evaluate how well the user has learned the taught subject and adjusting the taught material based on the user responses. However, traditional educational software is not able to receive and analyze any text written by the user in response to a question. A written answer can provide details as to how well a user understands a subject and the nuances relating to the subject.

A student submits a text answer into a graphical user interface (GUI), where the text answer can be directly written into the GUI or it can be a separate file that is uploaded into the GUI. The educational software utilizes natural language processing (NLP) to break up the submitted text into a plurality of triads. A triad is a set of three words composted of a subject, object and verb. Using NLP engines, the sentences are split into the nouns and verbs and the triads are created. A multiple steps analysis is performed of each of the triads, for example, the analysis includes identifying the definition of the words of the triad and the definitions is compared to the subject of the asked question to determine if the triad is related to the question. Another step of the analysis is to determined synonyms for each of the triads and determine if the synonyms are related to the asked question. The purpose of the analysis determines if there is any gaps or missing elements in the submitted answer. Once the analysis is complete a report is generated to be sent to user that details how well their answer related to the question. The educational software adjusts the education material to emphasize the areas of the subject matter that were identified as being missing, lacking, and/or not sufficient in the user submitted answer.

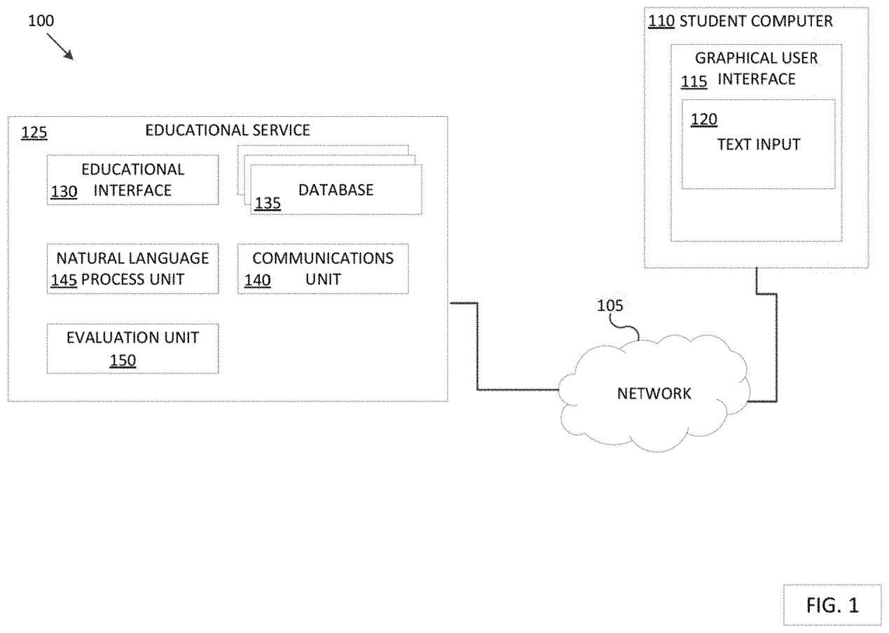

FIG. 1 is a functional block diagram illustrating a distributed educational platform processing environment 100, in accordance with an embodiment of the present invention.

The distributed educational platform processing environment 100 includes a network 105, student computer 110, and an educational service 125.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between the student computer 110 and the educational service 125.

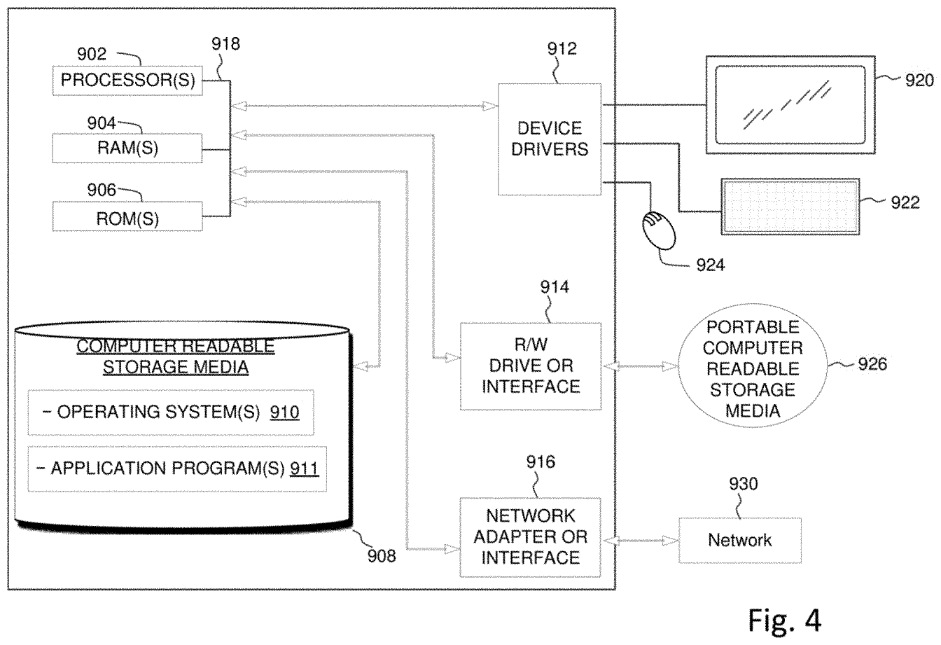

Student computer 110 may be a laptop computer, tablet computer, netbook computer, personal computer (PC), a desktop computer, a personal digital assistant (PDA), a smart phone, or any programmable electronic device capable of communicating with the educational service 125 via network 110. The student computer 110 includes graphical user interface (GUI) 115 and a text input 120. The text input 120 can be include as a feature in the GUI 115 where it allows a student to type out a textual answer to a questions and/or the text input 120 can be a feature that allows a student to upload a separately written text file. Student computer 110 may include internal and external hardware components, as depicted and described in further detail with respect to FIG. 4.

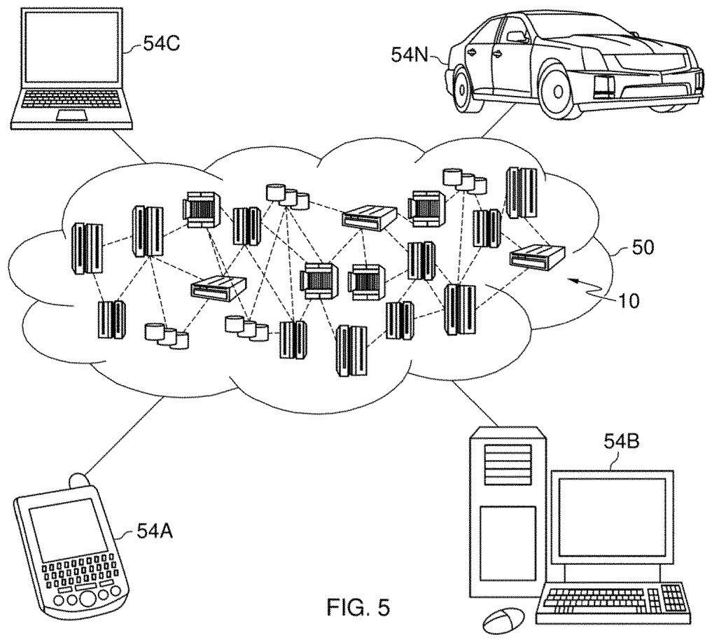

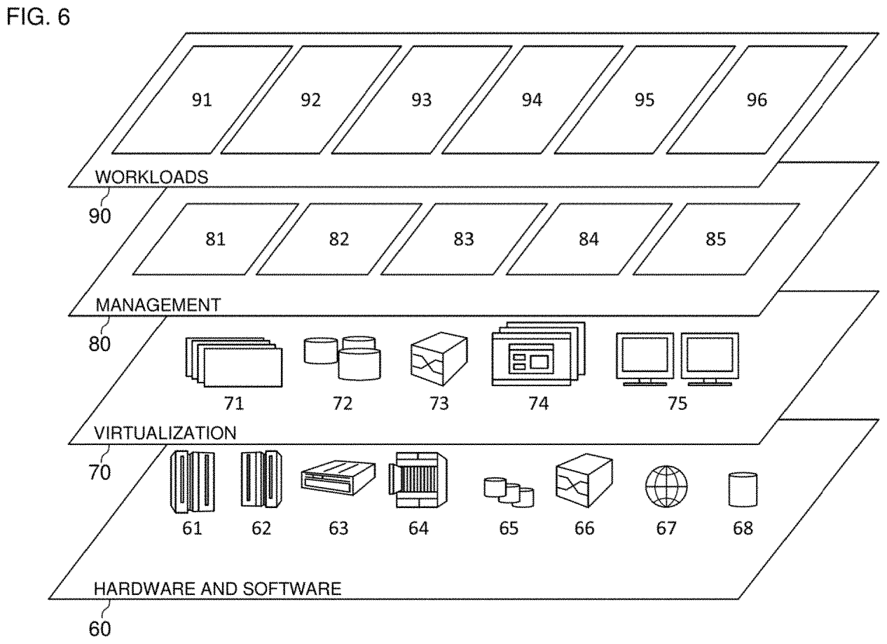

The education service 125 can be located on a server. In other embodiments, the server containing the educational service 125 may include internal and external hardware components, as depicted and described in further detail below with respect to FIG. 4, and operate in a cloud computing environment, as depicted in FIGS. 5 and 6.

The educational service 125 includes an educational interface 130, at least one database 135, a communications unit 140, a natural language processing unit 145, and an evaluation unit 150. The educational services 125 provides online education, distant learning, or automatic education to the student computer 110. The educational interface 130 accesses databases 135 to provide educational services to the student computer 110. The databases 135 can contain, for example, educational material, example triads related to the educational subject, synonym lists for different words, definitions of words, or other educational related material. The educational services can be, for example, video, audio, to text lessons about a wide variety of subjects. The educational interface 130 sends different types of questions to student computer 110 for the student to answer. The questions can be multiple choice, equations (for math education), or questions that require the student to write a text response. The communications unit 140 sends the educational material and the questions to the student computer 110 and receives the responses back from the student computer 110.

When the educational interface 130 sends a question that requires a text response, the text must be analyzed to determine how well the student understood the educational material that was provided. The natural language processing unit 145 and the evaluation unit 150 analyze the received text answer to determine how well the student understood the received educational material. The analysis process will be described in further detail below. The educational interface 130 receives the analysis report and transmits the report to the student computer 110. The report contains information as to what areas in the subject that the student missed, omitted, not understood, and/or was wrong in the analyzed received text answer. The educational interface 130 takes the information contained within the report and automatically adjusts the educational material provided to the student to emphasize the areas identified in the report.

In the analysis process is that the natural language processing unit 145 breaks up the received text into a plurality of triads. Each of the triads is comprised of a subject, a verb, and an object. The triads can be comprised of three or more words, and the words can be repeated in a plurality of different triads. For example, if the students text response states: Inertia is a property of objects to continue to be in a state of rest or uniform motion at a constant velocity. A force faces a resistance due to inertia of the object when it tries to change the velocity or direction. The natural language process unit 145 can, for example, break the student response into the following triads: inertia is property, property of objects to be in state, force faces resistance, object changes velocity. Once the triads are generated from the received text, then the evaluation unit 150 performs a multi-stage evaluation. The evaluation unit 150 determines the number of triads stored in the database 135 that relates to the subject matter of the text response. The evaluation unit 150 compares the number of triads in the student response and the number of triads stored in the database 135. The evaluation unit 150 determines if the number triads is less than, equal to, or greater than the number of triads stored in the database 135.

The second step, the evaluation unit 150 creates a first tensor, i.e. a list, of meanings for each of the triads created from the student text response. This is done by obtaining the meaning of words from a dictionary and if it's a named entity, using a NER list. By obtaining the triads used, the first tensor list provides the first level of expression by the student. The word meanings are obtained to gain an understanding of the student's comprehension. The evaluation unit 150 assigns a value to each of the items on the first tensor listed where the assigned value indicates the student understanding of each item relating to the subject matter. The assigned value quantifies how well the students response corresponds to the information contained within the database 135 relating to the subject matter.

Some students may use different words or phrases to describe one or more items relating to the educational subject matter. The evaluation unit 150 in the next step creates a second tensor, i.e. a list, of synonyms and their meanings for each of the items in the first tensor list described above. The evaluation unit 150 determines the meanings of each of the synonyms in the second tensor list and the evaluation unit 150 determines if the meanings of the synonyms relates to the subject matter of the response. The evaluation unit 150 assigns a value to each of the items on the synonyms tensor list to indicate the student understanding of the subject matter.

The evaluation unit 150 determines the meaning areas for the for the first and second tensor list. The evaluation unit 150 compares the meanings of each of the items of the first tensor list and the second tensor list to each other. The evaluation unit 150 determines the overlap of the meanings and the differences of the meaning. The evaluation unit 150 compares to the overlap of the meanings to the information contained within database 135 and compares the differences of the meanings to the information contained within the database 135. The evaluation unit 150 assigns a value to each item to represent the student's comprehension of the educational material.

The evaluation unit 150 accumulates the data from the first tensor list and the second tensor list. The evaluation unit 150 determines the concepts, topics, and ideas from the accumulated data. The evaluation unit 150 generates a third list, which is compilation the accumulated data and the determined concepts, topics and ideas. The third list represents a topic/concept/idea as described by the student in their textual answer.

The evaluation unit 150 determines at each stage of the evaluation the differences between the student submitted textual answer and the education material in database 135. The differences identified at each stage represent how well the student comprehends the educational material. For example, if differences are found at the first stage of evaluation, it illustrates that the student does not have a good comprehension of the educational material. Differences found in the additional stages of the evaluation illustrate the students understanding of the nuances, detail, and depth of the educational material. The evaluation unit 150 generates a report that illustrate the identified areas of comprehension and areas that the student did not comprehend. The communications unit 140 transmit the report to the student for their review.

Furthermore, the educational interface 130 takes the report to adjust the educational material provide to the student computer 110. The educational interface 130 provides educational material directed areas identified by the report where the students comprehension was determined to be lacking.

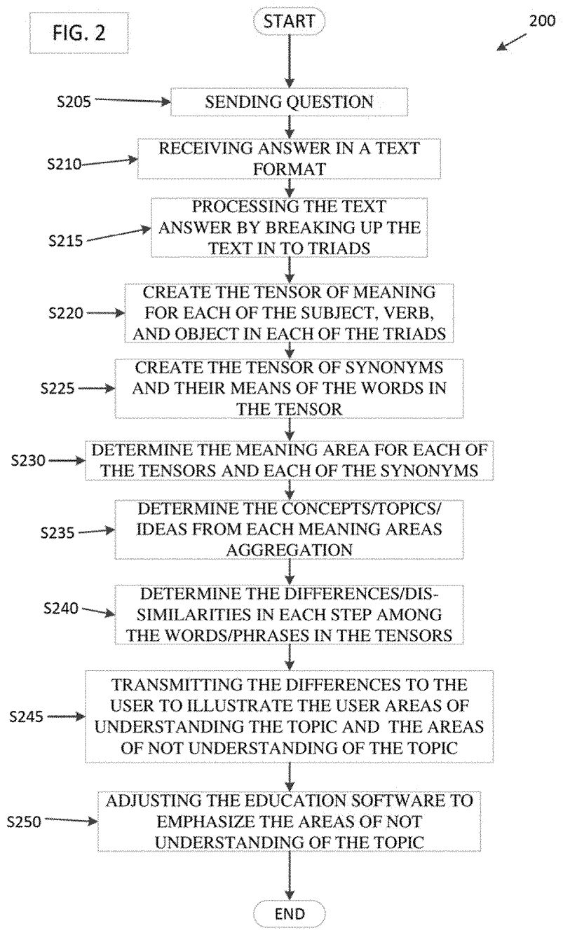

FIG. 2 is a flowchart depicting operational steps 200 of the educational platform process environment 100 of FIG. 1, in accordance with an embodiment of the present invention.

The education interface 140 sends a question to a student computer 110, where the question is related to previously sent or concurrently sent educational materials (S205). The communications unit 140 receives a text answer from the student computer 110 in response to the sent question (S210). The evaluation unit 150 breaks up the receives text into triads (S215). The first step in the analysis process is that the natural language processing unit 145 breaks up the received text into a plurality of triads. Each of the triads is comprised of a subject, a verb, and an object. The triads can be comprised of three or more words, and the words can be repeated in a plurality of different triads.

The educational service 125 includes an educational interface 130, at least one database 135, a communications unit 140, a natural language processing unit 145, and an evaluation unit 150. The educational services 125 provides online education, distant learning, or automatic education to the student computer 110. The educational interface 130 access databases 135 to provide educational services to the student computer 110. The databases 135 can contain, for example, educational material, example triads related to the educational subject, synonym lists for different words, definitions of words, or other educational related material. The educational services can be, for example, video, audio, to text lessons about a wide variety of subjects. The educational interface 130 sends different types of questions to student computer 110 for the student to answer. The questions can be multiple choice, equations (for math education), or questions that require the student to write a text response. The communications unit 140 sends the educational material and the questions to the student computer 110 and receives the responses back from the student computer 110. The evaluation unit 150 determines the number of triads stored in the database 135 that related to the subject matter of the text response. The evaluation unit 150 compares the number of triads in the student response and the number of triads stored in the database 135. The evaluation unit 150 determines if the number triads is less than, equal to, or greater than the number of triads stored in the database 135 that relate to the subject matter of the student text response (S215).

The evaluation unit 150 creates a first tensor, i.e. a list, of meanings for each of the triads created from the student text response (S220). This is done by obtaining the meaning of words from a dictionary and if it's a named entity, using a NER list. By obtaining the triads used, the first tensor list provides the first level of expression by the student. The word meanings are obtained to gain an understanding of the student's comprehension. The evaluation unit 150 assigns a value to each of the items on the first tensor listed where the assigned value indicates the student understanding of each item relating to the subject matter. The assigned value relates to showing how well the students response corresponds to the information contained within the database 135 relating to the subject matter.

Some students may use different words or phrases to describe one or more items relating to the educational subject matter. The evaluation unit 150 in the next step creates a second tensor, i.e. a list, of synonyms and their meanings for each of the items in the first tensor list described above (S225). The evaluation unit 150 determines the meanings of each of the synonyms in the second tensor list and the evaluation unit 150 determines if the meanings of the synonyms relate to the subject matter of the response. The evaluation unit 150 assigns a value to each of the items on the synonyms tensor list to indicate the student understanding of the subject matter.

The evaluation unit 150 determines the meaning areas for the for the first and second tensor list (S230). The evaluation unit 150 compares the meanings of each of the items of the first tensor list and the second tensor list to each other. The evaluation unit 150 determines the overlap of the meanings and the differences of the meaning. The evaluation unit 150 compares to the overlap areas and the divergent areas to the information contained within database 135. The evaluation unit 150 assigns a value to each item to represent the student's comprehension of the educational material.

The evaluation unit 150 generates an aggregation of data from the first tensor list and the second tensor list (S235). The evaluation unit 150 determines the concepts, topics, ideas from the aggregated data. The evaluation unit 150 generates rates a third list, which is complies the aggregated data and the determined concepts, topics and ideas (S235). The third list represents a topic/concept/idea as described by the student in their textual answer.

The evaluation unit 150 determines at each stage of the evaluation the differences between the student submitted textual answer and the education material in database 135 (S240). The differences identified at each stage represent how well the student comprehends the educational material. For example, if differences are found at the first stage of evaluation, it illustrates that the student does not have a good comprehension of the educational material. Difference found in the additional stages of the evaluation illustrate the students understanding of the nuances, detail, and depth of the educational material. The evaluation unit 150 generates a report that illustrate the identified areas of comprehension and areas that the student did not comprehend. The communications unit 140 transmit the report to the student for their review (S245).

Furthermore, the educational interface 130 takes the report to adjust the educational material provide to the student computer 110 (S250). The educational interface 130 provides educational material directed areas identified by the report where the student's comprehension was determined to be lacking.

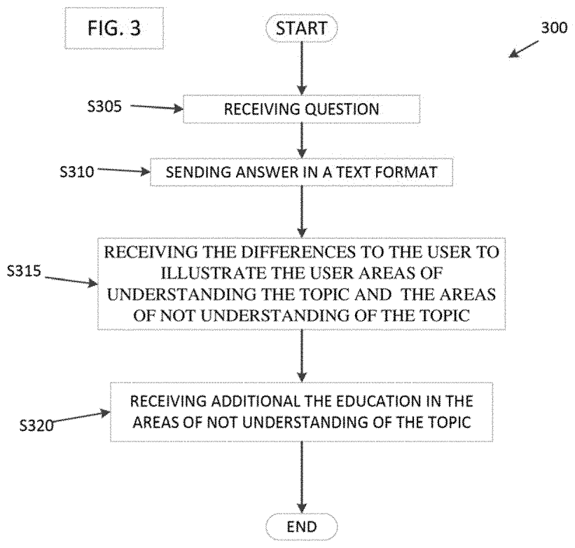

FIG. 3 is a flowchart depicting operational steps of the educational platform process environment 100 of FIG. 1 from the perspective of a student, in accordance with an embodiment of the present invention.

The student computer 110 receives a question for the student to answer and displays the question in the graphical user interface 115 (S305). The student inputs his test answer into the text input 120 and sent to the educational service 125 for evaluation (S310). The student computer 110 receives report from the educational service 125 that identifies the areas of student comprehension and areas where the student comprehension was lacking (S315). The student computer 110 receives educational material direction towards the areas where the student comprehension was lacking (S320).

FIG. 2 depicts a block diagram of components of education service 125 and the student computer 110 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

The educational service 125 and the student computer 110 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, educational interface 130 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The educational service 125 and the student computer 110 may also include a R/W drive or interface 914 to read from and write to one or more portable computer readable storage media 926. Application programs 911 on the educational service 125 and the student computer 110 may be stored on one or more of the portable computer readable storage media 926, read via the respective R/W drive or interface 914 and loaded into the respective computer readable storage media 908.

The educational service 125 and the student computer 110 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OF DMA) technology). Application programs 911 on the educational service 125 and the student computer 110 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The educational service 125 and the student computer 110 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and educational interface 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method comprising:
receiving, by a computer, a text answer to an educational related question from a student;
breaking up, by the computer, the text answer into a plurality of triads;
evaluating, by the computer, the plurality of triads to determine the student's comprehension of an educational subject that corresponds to the educational related question;
determining, by the computer, that the student's comprehension is lacking relating to the educational subject; and
automatically adjusting, by the computer, educational materials provided to the student, wherein the adjusted educational materials focuses on the areas of the educational subject that the student's comprehension was determined to be lacking.

2. The method of claim 1, wherein the each of the plurality of triads is comprised of a subject, a verb, and an object from the text answer.

3. The method of claim 1, wherein the educational materials are comprised of an audio file, a text file, or a video file that corresponds to the educational subject.

4. The method of claim 1, wherein the evaluation of the plurality of triads comprises:
counting, by the computer, the number of triads formed from the text answer;
retrieving, by the computer, from a database a plurality of stored triads corresponding to the educational related question, and counting, by the computer, the number of retrieved stored triads;
comparing, by the number, the number of triads formed from the text answer and the number of stored triads; and
determine, by the computer, a first level of comprehension based on the comparison of the number of triads formed from the text answer and the number of stored triads.

5. The method of claim 4, wherein the evaluation of the plurality of triads further comprises:
generating, by the computer, a list of meaning for each of the plurality of triads formed from the text answer;
retrieving, by the computer, from the database a plurality of stored meanings corresponding to the educational related question;
comparing, by the computer, the generated list of meanings for each of the plurality of triads formed from the text answer to each of the a plurality of stored meanings corresponding to the educational related question, wherein the comparison identifies where the generated meanings and the stored meanings overlap and identifies where the generated meanings and stored meanings diverge; and
assigning, by the computer, a value to each of the generated meanings, wherein the assigned value represents the student's comprehension of the educational subject related to the question.

6. The method of claim 5, wherein the evaluation of the plurality of triads further comprises:
generating, by the computer, a list of synonyms, for each of the items on the generating list of meanings;
generating, by the computer a second list of meanings for each of the items on the list of synonyms;
comparing, by the computer, the generated second list of meanings for each of the synonyms to each of the plurality of stored meanings corresponding to the educational related question, wherein the comparison identifies where the generated meanings and the stored meanings overlap and identifies where the generated meanings and stored meanings diverge; and
assigning, by the computer, a value to each of the generated second list of meanings, wherein the assigned value represents the student's comprehension of the educational subject related to the question.

7. The method of claim 6, wherein determining, by the computer, that the student's comprehension is lacking relating to the educational subject comprises:
aggregating, by the computer, the assigned values that illustrate the student's comprehension;
comparing, by the computer, the aggregation of values to a list of comprehension values stored in the database that relate to the education subject of the related question; and
generating, by the computer, a report illustrating the students' comprehension and lack of comprehension of the educational subject.

8. The method of claim 7, further comprises sending the generated report to the student for their review.

9. The method of claim 7, wherein the automatically adjusting the educational materials is based on the generated report.

10. A computer program product comprising:
one or more non-transitory computer-readable storage media and program instructions stored on the one or more non-transitory computer-readable storage media, the program instructions comprising:
program instructions to receive a text answer to an educational related question from a student;
program instructions to break up the text answer into a plurality of triads;
program instructions to evaluate the plurality of triads to determine the student's comprehension of an educational subject that corresponds to the educational related question;
program instructions to determine that the student's comprehension is lacking relating to the educational subject; and
program instructions to automatically adjust educational materials provided to the student, wherein the adjusted educational materials focus on the areas of the educational subject that the student's comprehension was determined to be lacking.

11. The computer program product of claim 10, wherein the each of the plurality of triads is comprised of a subject, a verb, and an object from the text answer.

12. The computer program product of claim 10, wherein the educational materials are comprised of an audio file, a text file, or a video file that corresponds to the educational subject.

13. The computer program product of claim 10, wherein the evaluation of the plurality of triads comprises:
program instructions to count the number of triads formed from the text answer;
program instructions to retrieve from a database a plurality of stored triads corresponding to the educational related question, and counting, by the computer, the number of retrieved stored triads;
program instructions to compare the number of triads formed from the text answer and the number of stored triads; and
program instructions to determine a first level of comprehension based on the comparison of the number of triads formed from the text answer and the number of stored triads.

14. The computer program product of claim 13, wherein the evaluation of the plurality of triads further comprises:
program instructions to generate a list of meaning for each of the plurality of triads formed from the text answer;
program instructions to retrieve from the database a plurality of stored meanings corresponding to the educational related question;
program instructions to compare the generated list of meanings for each of the plurality of triads formed from the text answer to each of the a plurality of stored meanings corresponding to the educational related question, wherein the comparison identifies where the generated meanings and the stored meanings overlap and identifies where the generated meanings and stored meanings diverge; and
program instructions to assign a value to each of the generated meanings, wherein the assigned value represents the student's comprehension of the educational subject related to the question.

15. The computer program product of claim 14, wherein the evaluation of the plurality of triads further comprises:
program instructions to generate a list of synonyms, for each of the items on the generating list of meanings, program instructions to generate a second list of meanings for each of the items on the list of synonyms;
program instructions to compare the generated second list of meanings for each of the synonyms to each of the plurality of stored meanings corresponding to the educational related question, wherein the comparison identifies where the generated meanings and the stored meanings overlap and identifies where the generated meanings and stored meanings diverge; and
program instructions to assign a value to each of the generated second list of meanings, wherein the assigned value represents the student's comprehension of the educational subject related to the question.

16. The computer program product of claim 15, wherein determining, by the computer, that the student's comprehension is lacking relating to the educational subject comprises:
program instructions to aggregate the assigned values that illustrate the student's comprehension;
program instructions to compare the aggregation of values to a list of comprehension values stored in the database that relate to the education subject of the related question; and
program instructions to generate a report illustrating the students' comprehension and lack of comprehension of the educational subject.

17. The computer program product of claim 16, further comprises sending the generated report to the student for their review.

18. The computer program product of claim 16, wherein the automatically adjusting the educational materials is based on the generated report.

19. A computer system comprising:
one or more computer processors, one or more computer-readable storage media, and program instructions stored on one or more of the computer-readable storage media for execution by at least one of the one or more processors, the program instructions comprising:
program instructions to receive a text answer to an educational related question from a student;
program instructions to break up the text answer into a plurality of triads;
program instructions to evaluate the plurality of triads to determine the student's comprehension of an educational subject that corresponds to the educational related question;
program instructions to determine that the student's comprehension is lacking relating to the educational subject; and
program instructions to automatically adjust educational materials provided to the student, wherein the adjusted educational materials focus on the areas of the educational subject that the student's comprehension was determined to be lacking.

20. The computer system of claim 19, wherein the each of the plurality of triads is comprised of a subject, a verb, and an object from the text answer.
